(19) United States
(12) Patent Application Publication
(10) Pub. No.: US 2016/0227610 A1
(43) Pub. Date: Aug. 4, 2016

(54) Arrangement Having a Ferromagnetic Work Piece and a Heating Winding Arranged Around at Least One Section of the Work Piece

(71) Applicant: CONTINENTAL AUTOMOTIVE GMBH, Hannover (DE)

(72) Inventors: STEPHAN BOLZ, RUHPOLDING (DE); MARTIN GOETZENBERGER, INGOLSTADT (DE); GERHARD HAFT, LAPPERSDORF (DE)

(21) Appl. No.: 14/917,330

(22) PCT Filed: Sep. 9, 2014
(86) PCT No.: PCT/EP2014/069169

§ 371 Date: Mar. 8, 2016

(30) Foreign Application Priority Data
Sep. 9, 2013 (DE) 10 2013 217 923.5

(51) Int. Cl. H05B 6/10; H05B 6/36

(52) U.S. Cl. CPC H05B 6/108; H05B 6/362

(57) ABSTRACT

An arrangement includes a ferromagnetic work piece and a heating winding arranged around at least a segment of the work piece for inductively heating the work piece. A layer of highly conductive material is arranged between the work piece and the heating winding. In a further development, the heating winding can be surrounded by a ferromagnetic material on the sides of the heating winding not facing the work piece. The ferromagnetic material is in contact with the work piece in the region of the ends of the heating winding and has at least one continuous interruption in a longitudinal direction of the heating winding.

Fuel for spark ignition engines—in particular bio-ethanol—can be heated by means of a heating device placed in the injection valve, in order to improve the cold-starting behavior. DE 10 2011 085 680 A1 discloses such an injection valve with a heating winding which is arranged around the fuel duct and heats up metallic or ferromagnetic parts of the valve inductively by actuation with high-frequency current.

For this purpose, a part of the injection valve, denoted below as a work piece, is enclosed by an induction winding, with the result that when a suitable alternating voltage signal is applied to the induction winding a magnetic field is built up in the work piece. This work piece is either the valve housing itself or an additional element which is located in the injection valve and around which fuel flows. The magnetic field induces eddy currents in the work piece, which eddy currents generate losses in the electrical resistance of the work piece. The resulting heat is output to the fuel which is flowing around. If the work piece is composed of a ferromagnetic material, re-magnetization losses are additionally produced and these quite substantially improve the effectiveness of the heating of the work piece.

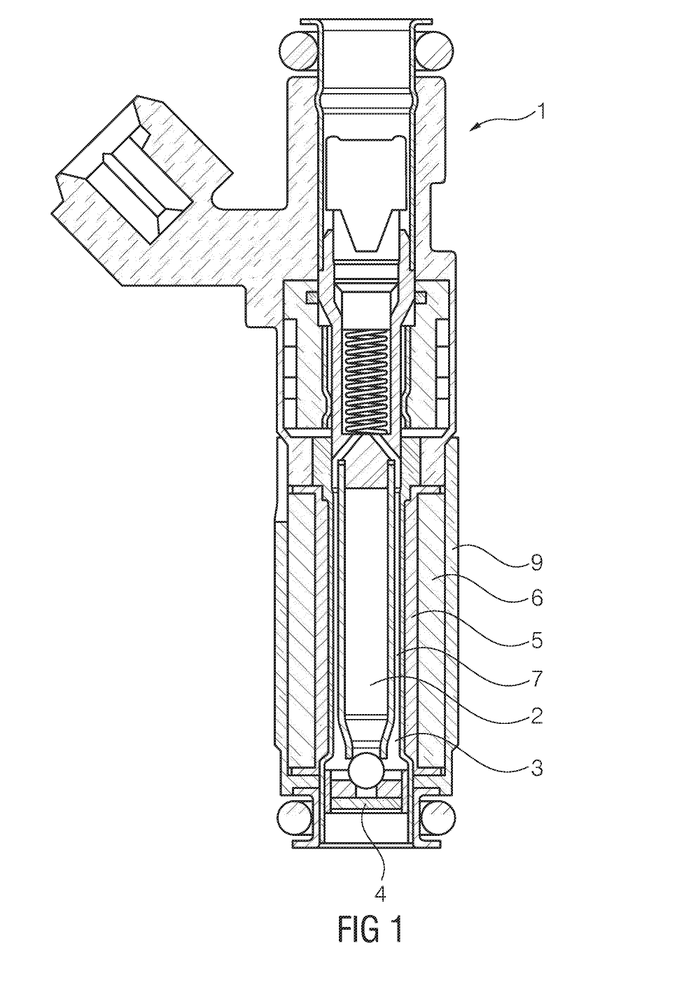

Such a known fuel injection valve 1 is illustrated in FIG. 1. The fuel outlet 4 of the fuel injection valve 1 is opened or closed by a magnetically activated valve needle 2. The valve needle 2 is movably mounted in a fuel duct 3, wherein the fuel duct 3 is formed in a valve housing 7. A winding carrier 5 with a heating winding 6 wound thereon is arranged around the valve housing 7. Arranged around the heating winding 6 is a casing 9 which protects it and is preferably made of plastic.

The part of the valve housing 7 which is surrounded by the heating winding 6 and, if appropriate, the valve needle serve as the work piece to be heated.

According to, for example, U.S. Pat. No. 3,506,907 energy can be applied to the heating winding 6 by means of a power semiconductor switch full-bridge circuit, wherein a series circuit composed of a capacitor and the heating winding is connected in the bridge circuit. By suitable actuating of the power semiconductor switches, the bridge circuit is operated in series resonance, with the result that the resulting transmission of energy from the motor vehicle battery inductively heats up the valve housing, and, if appropriate, the metallic valve needle.

DE 10 2011 085 085 A1 also discloses alternatively operating such a heating winding together with a capacitor in a parallel resonating circuit of an oscillator circuit arrangement.

These concepts have in common the resonant transmission of energy from the motor vehicle battery to the heating winding controlled by the control driver electronics. The resonant transmission of energy has proven very efficient, but power reactances, inter alia in the form of the specified capacitors, are necessary for the technical implementation. These components have, however, the disadvantage that they are relatively large/voluminous and expensive, which makes their use in control devices in automobile electronics unattractive. In the case of a four-cylinder engine with four injection valves, four power output stages are also usually necessary for reasons of fail safety with the result that the reactances determine the size and costs of the control driver electronics to a significant extent.

However, DE 34 15 967 A1 discloses operating the heating winding directly by means of power output stage transistors, connected as a H bridge, from a direct current source, acquired there by rectification of a three-phase voltage, without additionally raising the voltage by increasing the resonance.

However, the use of the conventional heating windings which are fabricated by windings of round wires on coil carriers then does not produce a satisfactory result in terms of the transmissible effective power, since owing to the high reactive power with peak currents up to 40 A large losses occur in the power output stages and the feed lines.

The object of the invention is therefore to avoid this problem.

The object is achieved by means of an arrangement having a ferromagnetic work piece and a heating winding which is arranged around at least one section of the work piece, as claimed in claim 1. Advantageous developments of the invention are specified in the dependent claims.

The avoidance of power reactances with good transmission of effective power is achieved according to claim 1 by means of a highly conductive coating of the work piece, which is, in particular a fuel injection valve stem, wherein the conductive coating is arranged between the work piece and heating winding.

In one advantageous embodiment of the invention, the thickness of the layer of the highly conductive material is less than 50 μm, wherein the highly conductive material is preferably copper.

As a result, the effective power which is available as heating power can be significantly increased owing to a relatively low ohmic resistance of the work piece to be heated.

In one particularly advantageous development of the arrangement according to the invention, the heating winding is surrounded, on its sides which do not face the work piece, by a ferromagnetic material which is contact with the work piece in the region of the ends of the heating winding and has at least one continuous interruption in the longitudinal direction of the heating winding.

A magnetically highly conductive return is therefore implemented, which brings about an increase in the main inductance of the heating winding and permits, in conjunction with a small effective resistance of the work piece which serves as the short-circuited secondary winding, the impedance of the heating winding for the feeding source to appear to be a purely ohmic resistance with the result that a further increase in the effective power is possible without an increase in the current, which entails losses.

The interruption in the longitudinal direction of the casing of the heating winding is necessary in order to prevent eddy currents in the casing.

In a further advantageous development of the invention, a thin layer made of insulating material is arranged between the layer made of a highly conductive material and the heating winding.

As a result, the leakage inductance of the heating winding can be significantly reduced, compared to conventional winding carriers.

In order to reduce the ohmic resistance of the heating winding with the smallest possible installation space, the heating winding is formed with an electrically highly conductive wire with a rectangular cross section and an electrically insulating coating.

The invention will be explained in more detail below by means of an exemplary embodiment and using figures. In the drawing:

FIG. 1 shows a fuel injection valve with a heating winding for inductive heating according to the prior art,

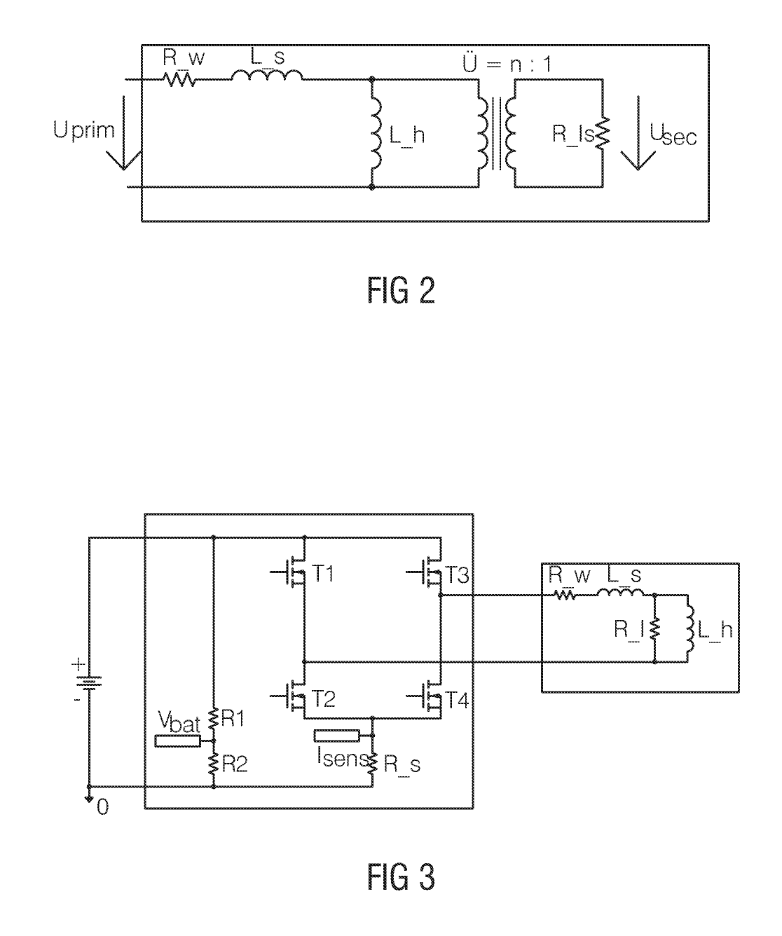

FIG. 2 shows a transformer equivalent circuit diagram for a heating winding on a work piece,

FIG. 3 shows an actuation circuit for a heating winding for inductive heating, and

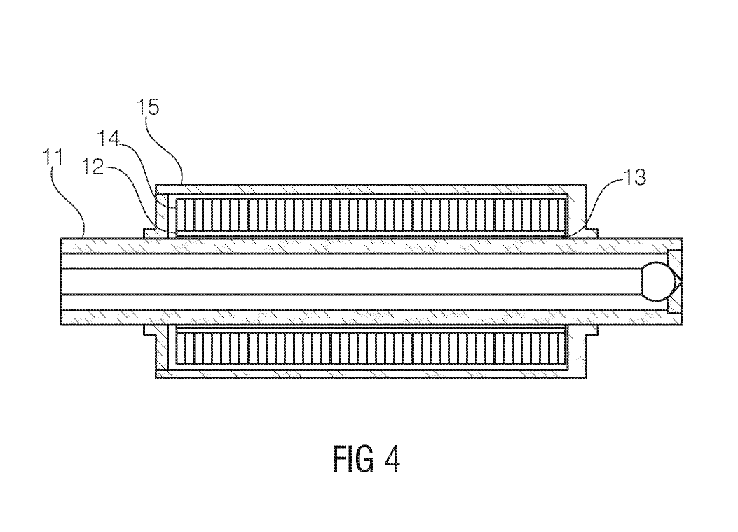

FIG. 4 shows an arrangement according to the invention with a work piece formed as a fuel injection valve and a heating winding arranged thereon.

An arrangement according to the invention which is formed with a heating winding 6 and the work piece 7, 2 which is enclosed by it, in particular a section of a fuel injection valve stem, as illustrated in FIG. 1, can be considered to be a transformer whose equivalent circuit diagram is illustrated in FIG. 2. The valve stem section represents, in addition to its function as an iron core for conducting the magnetic field, also the secondary winding with a single, short-circuited turn. The electrical resistance of the valve body and its geometry result in a resistance in the circumferential direction, which constitutes a secondary-side load resistance R_Is. Here the following applies:

R_Is=R_I/n²

or

R_I=R_Is*n²

wherein n=number of turns of the heating winding. R_I is therefore the back-transformed resistance of the valve stem material.

The secondary voltage Usec is formed by the transformed voltage at the heating winding Uprim.

Usec=Uprim/n

A heating power is therefore obtained as

P=Uprim²/R_I=Uprim²/(R_Is *n²)

In addition, the main inductance L_h, the winding resistance R_w and the leakage inductance L_s are also represented in FIG. 2.

In an equivalent circuit diagram with transformed, effective load resistance R_I and a full-bridge circuit with power transistors T1, T2, T3, T4 are illustrated as an indication of control electronics in FIG. 3. In order to generate an alternating voltage at the heating winding, the transistors T1 and T4 or T2 and T3 are alternately switched on and off periodically.

Owing to the inductance of the heating winding and in this context mainly owing to the main inductance L_h, the time profile of the current through the heating winding occurs by means of a virtually linear rise or drop in current. The smaller the value of the main inductance L-h, the steeper the rising edges or falling edges, which give rise to an unfavorable ratio of effective power to reactive power. The highest possible main inductance L_h is therefore desired.

The heater voltage Uprim is fixed, based on the supply from the motor vehicle on-board power system voltage. The resistance of the valve body material which is effective on the secondary side is also largely fixed by the design. In order to be able to set a desired heating power, the transmission ratio of the transformer, that is to say the number of turns of the heating winding, remains the single free parameter according to the above formula. Reducing the new number of turns reduces the effective resistance R_I which can be seen on the primary side, and therefore increases the heating power.

In order to approximately double the heating power, it would, however, be necessary to reduce the number of turns by approximately 30%. However, this would result in a halving of the value of the main inductance L_h. However, the associated rise in the reactive portion of the current is not desirable or acceptable.

According to the invention, this contradiction is remedied by an additional coating 12 of the valve body 11 as a work piece of the arrangement according to the invention with a low-impedance material, for example copper. This coating 12 which is illustrated in FIG. 4 gives rise to a further resistance which is connected in parallel with the valve body resistance, with the result that the entire load resistance R_I is reduced thereby. Since copper has a significantly higher electrical conductance than steel, a layer thickness of less than 50 μm is already sufficient. Increasing the layer thickness brings about a reduction in the load resistance and therefore an increase in the heating power.

The adaptation of the layer thickness and number of turns then makes it possible to set, on the one hand, the load resistance R_I for a desired heating power, and, on the other hand, at the same time the minimum required value of the main inductance L_h.

Since the heating winding is accommodated in the injection valve, there are, however, considerably restrictions on the installation space during its configuration. In order nevertheless to be able to bring about the desired main inductance, it is necessary to close the previously open magnetic circuit of the arrangement composed of the work piece and the heating winding. If the return of the magnetic circuit occurs outside the valve through the air, this increases the resistance of the magnetic circuit, which brings about a reduction in the coil inductance.

In an inventive development of the invention, a return 15 composed of a ferromagnetic material (for example steel) is then attached outside the winding 14, wherein a direct contact with the work piece 11 is provided at the two ends of said return 15. The magnetic circuit is therefore completely closed (without an air gap). The magnetic field then also flows through the return 15, and an eddy current is built up in the circumferential direction, precisely as in the case of the work piece 11 and the coating 12. However, this is undesirable since in this context effective power would come about in the return 15. Therefore, the return 15 must be slotted completely at least once in the longitudinal direction.

The value of the main inductance can be approximately doubled by means of the return 15 according to the invention, while the installation space is the same and the number of turns is unchanged.

A further problem is the leakage inductance L_s, since during the switch-over process it impedes the buildup of current in the heating winding 14. As a result, the heating power which is input in this time is reduced, which then has to be compensated in turn by increasing the effective current. The relatively high effective current is, however, undesired since it causes additional losses in the switching transistors and feed lines and therefore reduces the overall effectiveness of a heating system.

Leakage inductance arises as a result of deficient coupling between the primary and secondary windings of the transformer, wherein the two windings do not enclose a part of the magnetic flux in the same shape (leakage flux). When conventional winding carriers are used for the heating winding as shown in FIG. 1, an air gap is produced between the work piece and the heating winding in which a magnetic flux runs, around which the secondary current does not flow.

As a result of the reduction according to the invention in the air gap between the heating winding 14 and the electrically highly conductive coating 12, the value of the leakage inductance L_s can be reduced significantly. This is done by dispensing with a specific winding carrier and using a thin insulating coating 13 on the electrically highly conductive layer 12, that is to say between the latter and the heating winding 14.

In order to keep the wire resistance R_w as small as possible given a predefined coil length, in one development of the arrangement according to invention the heating winding 14 is embodied with a rectangular wire standing upright on its edge. A thin protective film, made, for example, from the high-strength plastic kapton, prevents damage to the winding insulation (enameled copper wire) during the joining process.

Since an arrangement which is modified according to the invention behaves electrically virtually as an ohmic resistance, a simple temperature determination can take place.

A significant part of the current which is induced on the secondary side flows through the coating 12 (preferably copper). The electrical conductance of copper decreases continuously as the temperature increases (approximately 0.39% per ° Celsius). Accordingly the impedance of the load resistance R_I becomes higher as the temperature increases, which gives rise to a reduction in the coil current.

If the coil current Isens is then measured, together with the coil voltage Vbat, which is indicated in FIG. 3, the load resistance R_I can be obtained therefrom. In this context, different resistance values are obtained for different arrangement temperatures. If this measurement is carried out at a known arrangement temperature, for example after relatively long stationary state of the vehicle, an arrangement temperature can be assigned to the load resistance R_I which is obtained. Since the relationship between the load resistance value and the temperature is linear, an assignment of a respectively currently obtained load resistance and an extrapolated arrangement temperature can be made from this point onward. The arrangement temperature which is obtained in each case in this way can then serve in turn as an actual variable for a temperature control process (not described here).

The optimization according to the invention of the arrangement with a ferromagnetic work piece with a heating winding which is arranged on at least one section of the work piece and has the purpose of inductively heating the work piece makes it possible to avoid completely the power reactances which are necessary in the prior art and therefore to reduce significantly the costs and overall size of the control electronics. The possible sensorless detection of temperature avoids any costs for a temperature sensor or specific, expensive ferromagnetic materials with temperature-dependent saturatization magnetization. The entire system is distinguished by a very good level of efficiency and low EMC radiation.

1-6. (canceled)

7. An arrangement, comprising:
a ferromagnetic work piece;
a heating winding arranged around at least one section of said work piece for inductively heating the work piece; and
a layer of highly conductive material disposed between said work piece and said heating winding.

8. The arrangement according to claim 7, wherein said layer of highly conductive material has a thickness of less than 50 μm.

9. The arrangement according to claim 7, wherein said highly conductive material is copper.

10. The arrangement according to claim 7, which comprises a ferromagnetic material surrounding said heating winding on sides thereof which do not face said ferromagnetic work piece, said ferromagnetic material being in contact with said ferromagnetic work piece in a region of the ends of said heating winding and being formed with at least one continuous interruption in a longitudinal direction of said heating winding.

11. The arrangement according to claim 7, which comprises a thin layer of insulating material disposed between said layer of a highly conductive material and said heating winding.

12. The arrangement according to claim 7, wherein said heating winding is formed of an electrically highly conductive wire with a rectangular cross section and an electrically insulating coating.
